(19) United States
(12) Patent Application Publication
(10) Pub. No.: US 2008/0110028 A1
(43) Pub. Date: May 15, 2008

(54) MULTIBLADE KNIFE UNIT

(75) Inventors: Brett P. Seber, Vista, CA (US); Eric B. Carmichael, Encinitas, CA (US); Wesley James Tom, Escondido, CA (US)

Correspondence Address: KELLY LOWRY & KELLEY, LLP, 6320 CANOGA AVENUE, SUITE 1650, WOODLAND HILLS, CA, 91367, US

(73) Assignee: I.D.L. TECH TOOLS, LLC, Summit, NJ (US)

(21) Appl. No.: 11/938,920

(22) Filed: Nov. 13, 2007

Related U.S. Application Data
(63) Continuation-in-part of application No. 11/559,362, filed on Nov. 13, 2006.

(51) Int. Cl. B26B 1/02

(52) U.S. Cl. 30/152

(57) ABSTRACT

A multiblade knife unit includes a first blade pivotally moveable between a folded position within a side edge of the handle, and an extended position projecting from one end of the handle. A second blade is supported by a carriage for sliding displacement between a contracted position stored within the handle, and an extended position projecting out from one end of the handle. The first and second blades being independently deployable out a common end of the handle. The knife unit includes a third blade slidably mounted to the handle housing, opposite the first and second blades, for sliding displacement between a retracted position within the handle and an extended position projecting generally out from a second end of the handle. The knife unit may further include a belt clip mounted to a housing for encasing a can opener.

### BACKGROUND OF THE INVENTION

This invention relates generally to an improved multiblade knife unit including a plurality of knife blades of different type normally stored within and adapted for deployment from a handle housing. More particularly, this invention relates to an improved multiblade knife unit wherein multiple knife blades such as a pivotally mounted knife blade and a slidably mounted utility blade are deployable from a common end of the handle housing.

Multiblade knife units are generally known in the art, wherein a plurality of knife blades are carried by a common knife handle. In such knife units, the handle comprises a housing structure adapted for movably supporting each of the multiple knife blades for individual displacement between a normal stored position nested at least partially within the handle housing, and a deployed position with a blade cutting edge exposed for use. In this regard, conventional so-called pocket knives are known wherein multiple pivoting knife blades are carried by the handle housing for pivoting displacement between the stored and deployed positions at a common end of the handle housing. Such pivoting knife blades normally comprise different-sized blades of a common style, e.g., such as conventional knife blades each having a cutting edge formed along one side thereof. In multiblade knife units of this type, a single one of the multiple knife blades is normally deployed for use at any given time. By contrast, while multiple blades can be deployed simultaneously, the blades typically define parallel cutting edges which are not normally useful in this configuration for performing different types of cutting tasks.

In recent years, interest has developed in alternative multiblade knife units having a plurality of knife blades of different types, particularly such as at least one pivotally mounted knife blade in combination with at least one slidably mounted razor-type utility knife blade. Such alternative multiblade knife units have incorporated these different types of knife blades in a common handle housing each for displacement between stored and deployed positions. In this regard, slidably mounted razor-type utility knives are also known in the art, and typically include a removably mounted razor blade having an extremely sharp cutting edge used to perform a variety of specialized cutting tasks, such as trimming wallboard during building construction and/or remodeling. However, multiblade knife units which combine a slidably mounted utility knife blade with a conventional pivotally mounted knife blade have generally deployed these different-style cutting blades from opposite ends of a common handle housing. Once again, while it is possible to deploy both types of knife blades at the same time, the oppositely projecting cutting edges pose a significant risk of use injury.

The present invention provides an improved multiblade knife unit having knife blades of different types, such as pivotally mounted knife blade and a slidably mounted utility blade, adapted for individual or concurrent deployment from a common end of a handle housing.

### SUMMARY OF THE INVENTION

In accordance with the invention an improved multiblade knife unit includes knife blades of different type normally stored within and adapted for deployment from a common end of a handle housing. A first, pivoting knife blade is supported for pivotal movement between a first folded position nested substantially within one side edge of the handle housing, and a second extended position projecting from one end of the handle housing. A second, razor-type utility knife blade is supported by a carriage for sliding displacement between a first contracted position stored and concealed within the handle housing, and a second extended position projecting from said one end of the handle housing. The two knife blades can be deployed independently, or concurrently.

The knife unit further includes a third blade, preferably a paint scraper. The third blade is slidably mounted to the handle for sliding displacement between a first retracted position within the handle and a second extended position projecting generally out from a second end of the handle. The paint scraper blade is preferably mounted to a blade holder slidably mounted within the handle for selectively moving the paint scraper between its first and second positions. Accordingly, the blade holder is accessible through the handle of the knife unit for manually moving the paint scraper between these first and second positions. A release mechanism integrated into the blade holder permits manual removal and replacement of the paint scraper when the paint scraper is in the extended position.

The pivotally mounted knife blade, in the preferred form, includes a short stub post positioned in spaced relation to the pivotally mounted end thereof, for fingertip engagement to facilitate knife blade displacement from the normally folded position to the extended position. A spring plate mounted within the handle housing shifts laterally in a first direction when the pivoting knife blade is in the extended position to engage and lock with a matingly shaped base end of the knife blade, thereby precluding unintended return movement from the extended position to the folded position. An edge of this spring plate is exposed and configured for fingertip engagement to shift the spring plate in a second direction, thereby releasing the knife blade and permitting pivotal return thereof to the folded position.

The slidably mounted utility blade is carried by a carriage mounted within the handle housing for displacement between the contracted and extended positions. The carriage is exposed through a slot formed in the handle housing to facilitate displacement therein. At least one mounting key on the carriage is normally seated within a mating mounting recess formed in the utility blade, whereby carriage displacement shifts the utility blade between the contracted and extended positions.

A release mechanism integrated into the handle housing is depressed for releasing the utility knife blade from the slide clip, thereby facilitating quick and easy slide-out blade removal and replacement. The release mechanism has a button carried at one end of a spring tab mounted within the handle housing. The button is externally exposed through a button port formed in the handle housing. When the carriage is shifted to the extended position, the button can be depressed to retract the mounting key on the carriage from the mounting recess on the utility blade, thereby releasing the utility blade for manual grasping and slide-out separation from the carriage and handle housing. Accordingly, a replacement utility blade with a sharp cutting edge can be slidably installed on the slide clip, followed by spring-retraction of the release button for re-engagement of the carriage mounting key with the blade mounting recess.

In another embodiment, the knife unit includes a can opener pivotably attached to the handle. The can opener may be stored in a housing formed as part of the handle. The can opener is fingertip accessible as its tip extends out from one end of the housing. The can opener may be pivoted from a first position, as stored within the housing, to a second position extending out from the handle. A belt clip may further be affixed to the handle, and preferably to the exterior of the housing. The belt clip is ideal for attaching the multiblade knife unit to a clothing article such as a belt, for hands-free transportation in times of non-use.

In another form, the knife unit may further include screwdriver bits, or alike such as scribes, or marking devises interchangeably mounted at an opposite end of the handle housing.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is top perspective view illustrating a multiblade knife unit in accordance with one preferred form of the present invention;

FIG. 2 is a top perspective view similar to FIG. 1, and showing a pivoting knife blade in a deployed position projecting outwardly from a handle housing;

FIG. 3 is a top perspective view similar to FIGS. 1 and 2, but depicting the pivoting knife blade in a stored position nested partially within the handle housing, and a razor-type utility blade in a slidably advanced position;

FIG. 4 is a bottom perspective view showing the utility blade in the advanced position projecting outwardly from the handle housing;

FIG. 5 is a partially exploded bottom perspective view illustrating the pivoting knife blade in the stored position, and the utility blade (in dotted lines) in the advanced position;

FIG. 6 is a further exploded bottom perspective view;

FIG. 7 is a compact perspective view similar to a portion of FIG. 6, and showing the internal components for slide-fit mounting of the utility blade within the handle housing;

FIG. 8 is an exploded perspective view of FIG. 7;

FIG. 9 is an enlarged sectional view taken generally on the line 9-9 of FIG. 4;

FIG. 10 is an enlarged sectional view similar to FIG. 9, but illustrating depression of a release button on the handle housing for slide-fit removal of the utility blade from the handle housing;

FIG. 11 is a side elevation view of the knife unit, taken generally on the line 11-11 of FIG. 1, and depicting the pivoting knife blade in the stored position;

FIG. 12 is a side elevation view similar to FIG. 9, but taken generally on the line 12-12 of FIG. 2, and showing the pivoting knife blade in the deployed position;

FIG. 13 is a top perspective view similar to FIG. 2, but showing one alternative preferred form of the invention;

FIG. 14 is an enlarged, fragmented, and partially exploded top perspective view corresponding generally with the encircled region 14 of FIG. 13;

FIG. 15 is a top perspective view of an alternative knife unit including a paint scraper;

FIG. 16 is a top perspective view similar to FIG. 15, illustrating projection of the paint scraper;

FIG. 17 is a bottom perspective view of the knife unit in FIG. 15, illustrating a can opener housing and corresponding belt clip;

FIG. 18 is a bottom perspective view similar to FIG. 17, illustrating the can opener extending from the handle;

FIG. 19 is a bottom perspective view similar to FIG. 18, illustrating the can opener extending from the handle and operating as the belt clip;

FIG. 20 is an alternative perspective view of the knife unit of FIG. 4, illustrating a door for encasing and exchanging the utility knife blade;

FIG. 21 is an exploded perspective view of the knife unit of FIG. 20;

FIG. 22 is a partially exploded top perspective view of the knife unit of FIG. 20; and

FIG. 23 is a partially exploded bottom perspective view of the knife unit of FIG. 20, illustrating attachment of the door.

### DETAILED DESCRIPTION OF THE PREFERRED EMBODIMENTS

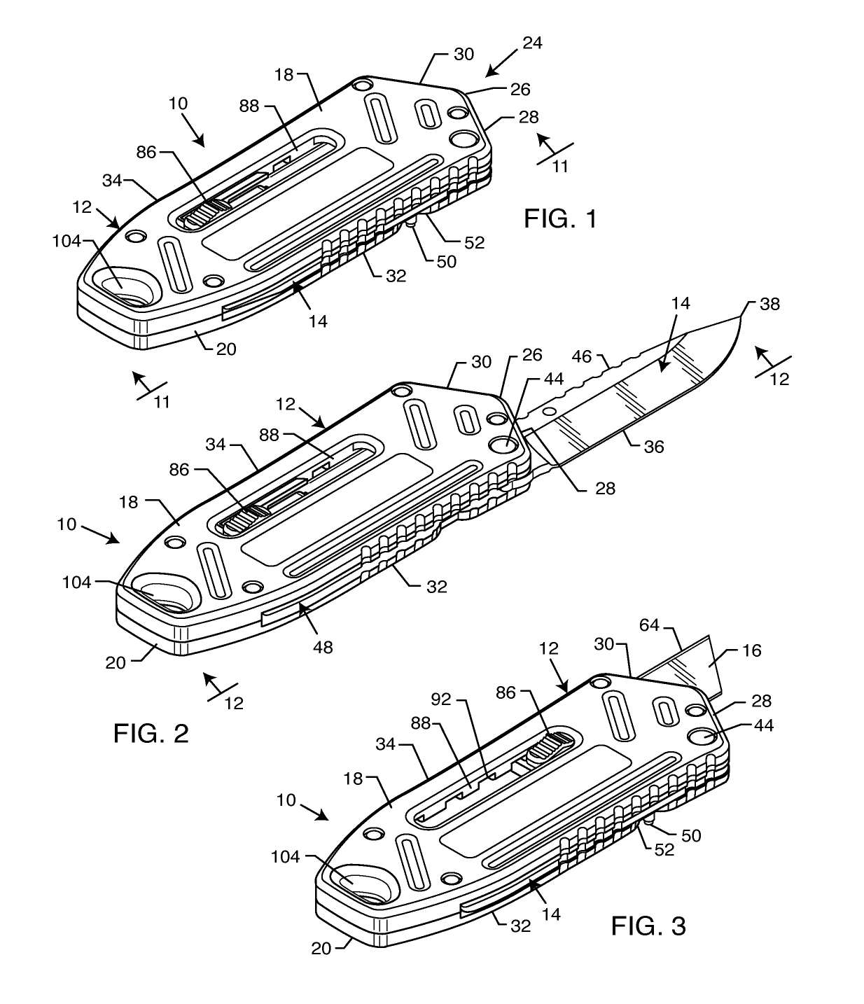

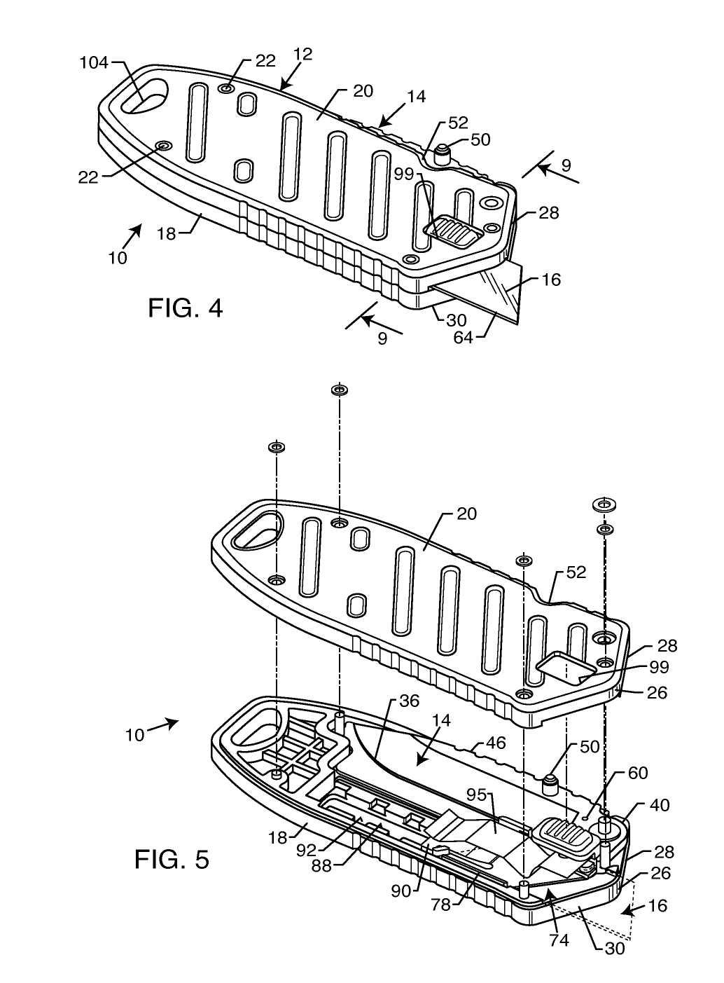

As shown in the exemplary drawings, a multiblade knife unit referred to generally in FIGS. 1-4 by the reference numeral 10, comprises a handle housing 12 carrying a plurality of knife blades of different types, wherein the multiple knife blades are adapted for movement between a normal stored position and a deployed position projecting outwardly from a common end of the handle housing 12. The exemplary drawings show the multiple knife blades in the form of a pivoting knife blade 14 (FIG. 2) and a slidably mounted razor-type utility blade 16 (FIGS. 3-4). Both blades 14, 16 can be deployed at the same time, if desired.

The handle housing 12 has a relatively compact and preferably externally textured or grooved geometry for facilitated manual grasping and holding during use and comprises an upper housing member 18 having a size and shape for mated fit with a lower housing member 20, and for secure interconnection therewith as by means of a plurality of rivet-type fasteners 22 or the like. When assembled, the upper and lower housing members 18, 20 support and encase the knife blades 14, 16 and associated mechanisms for displacing these knife blades 14, 16 between their respective stored and deployed positions. The housing member 18, 20 may be constructed conveniently from a lightweight reinforced plastic material.

In general terms, the illustrative pair of knife blades 14, 16 are mounted within the handle housing 12 generally in side-by-side relation. In this regard, a front end 24 of the handle housing 12 is shown to include a generally pointed or forwardly projecting central nose 26 bounded on opposite sides by a matched pair of tapered faces 28 and 30 which extend from the nose 26 in a lateral and angularly rearward direction toward the associated side edges 32 and 34 of the handle housing 12. In other words, the front end 24 of the handle housing 12 has a generally V-shaped configuration. The pivoting knife blade 14 is supported by the handle housing 12 for projecting in the deployed position (as viewed in FIG. 2) from the front tapered face 28 of the handle housing 12, whereas the slidably mounted utility blade 16 is supported for projecting in the deployed position (as viewed in FIGS. 3-4) from the front tapered face 30 of the handle housing 12. Accordingly, the two knife blades 14, 16 are independently supported by the handle housing 12 for separate and independent displacement between their respective stored and deployed positions. In this regard, although not shown in the exemplary drawings, persons skilled in the art will recognize and appreciate that the two knife blades 14, 16 can both be deployed at the same time, if desired.

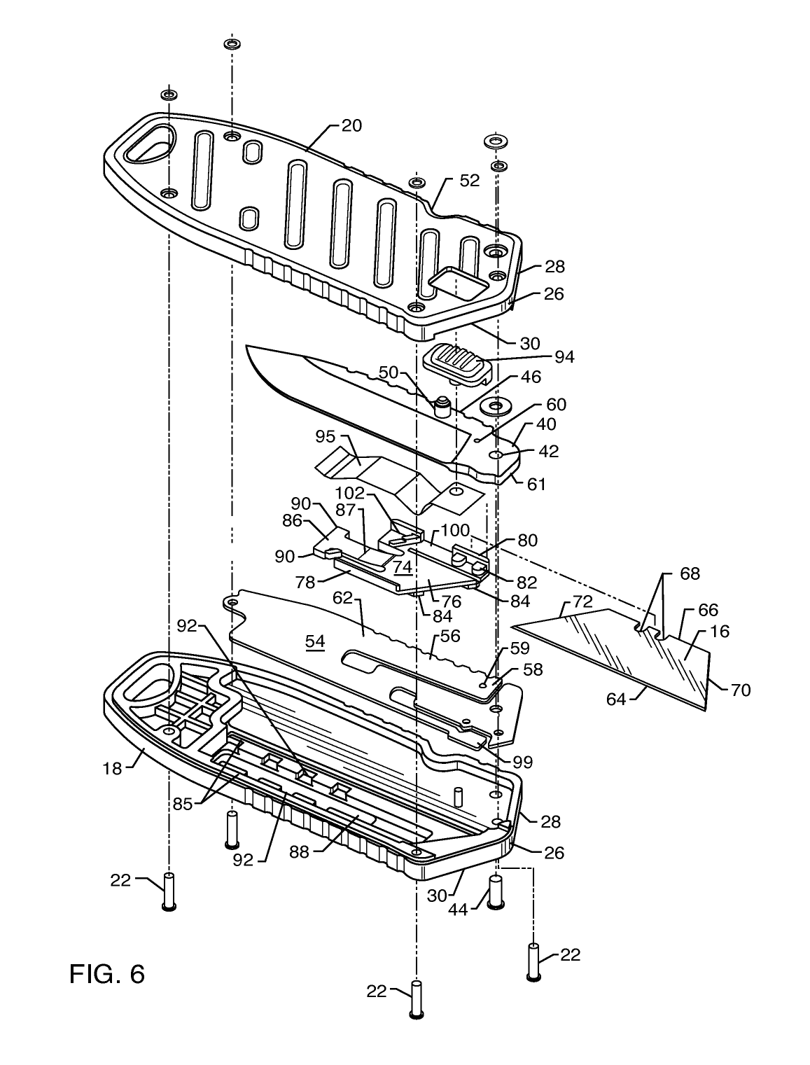

The pivoting knife blade 14 as shown comprises a conventional knife blade having an elongated cutting edge 36 formed along one side thereof and terminating at a pointed distal end tip 38. An oppositely disposed and non-sharpened base end 40 (shown best in FIG. 6) has a pivot port 42 formed therein for secure mounting between the housing members 18, 20 as by means of suitable pivot pin 44 fastened between the housing members 18, 20 near the angled front face 28. The knife blade 14 further includes a blunt and preferably serrated side edge 46 disposed opposite the cutting edge 36.

The pivoting knife blade 14 is sized and shaped for normal nested reception in the stored position seated at least partially within a laterally open slot 48 defined in the housing side edge 32 between the assembled housing members 18, 20 (shown best in FIGS. 2 and 9-10). In this stored position, the sharp cutting edge 36 on the knife blade 14 is in an inboard-facing orientation (shown best in FIG. 5), and the blunt side edge 46 is in an outboard-facing orientation, thereby safeguarding against accidental contact with the cutting edge 36. A short stub post 50 mounted on the knife blade 14 in a position spaced a short distance from the base end 40 is nested at least partially within a laterally open notch 52 defined by the lower housing member 20.

To displace the pivoting knife blade 14 from the stored position to the deployed position, the stub post 50 is sufficiently exposed within the notch 52 for fingertip access as by the user's thumb for swinging the knife blade 14 outwardly from the stored position within the nested slot 48 to the deployed position projecting forwardly from the angled front face 28 at the front end 24 of the handle housing 12. In this orientation, the pointed distal end tip 38 is presented in a forward direction extending away from the housing handle 12, and the cutting edge 36 is presented in a laterally outboard direction relative to the handle housing 12.

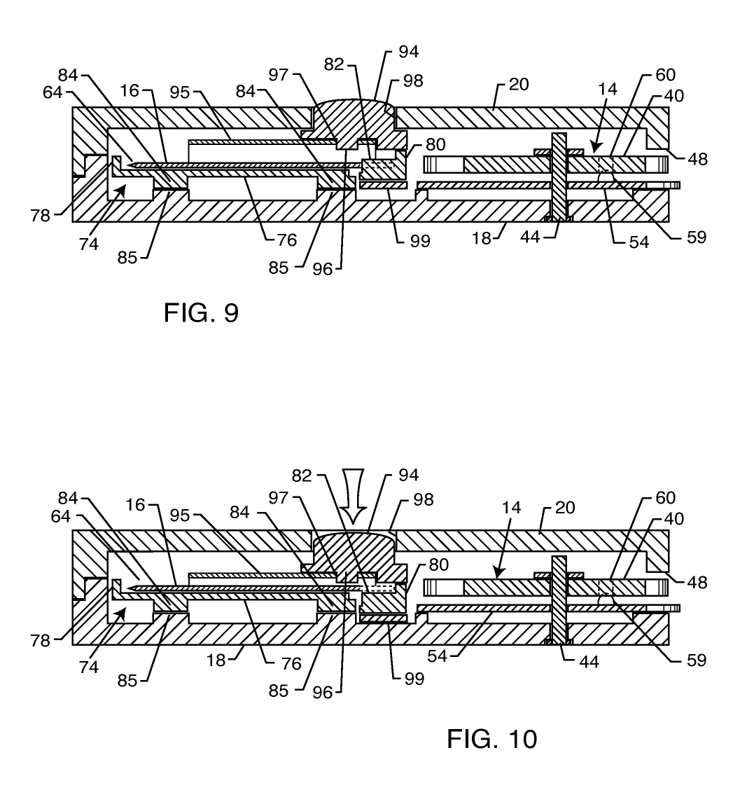

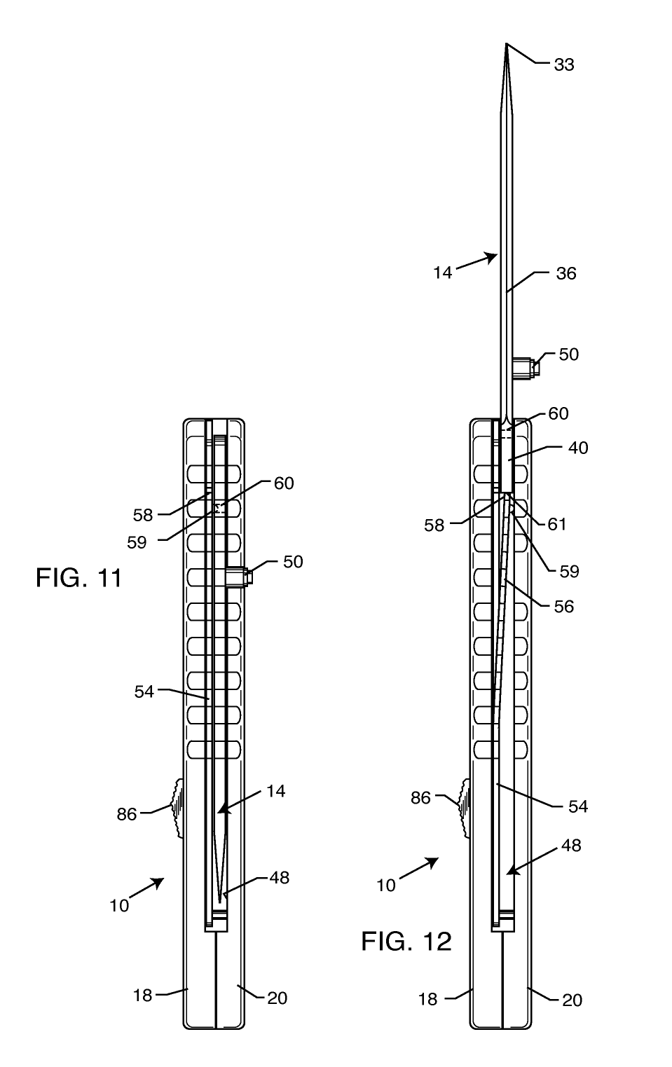

In accordance with one aspect of the invention, the knife unit 10 includes a releasible locking device for releasibly locking the pivoting knife blade 14 in the deployed position, thereby safeguarding against undesired or premature re-folding of the knife blade 14 back to the stored position. In a preferred embodiment, a spring member such as a spring plate 54 (shown best in FIGS. 6-10) is mounted within the handle housing 12 in a position sandwiched between the housing members 18, 20. This spring plate 54 includes a spring member 56 for locking the pivoting knife blade in either a deployed or retracted position. The spring member 56 has a front end 58 for locking the pivoting knife blade 14 in a deployed position as further described herein. When the pivoting knife blade 14 is in the stored position, a ball detent 59, located near the front end 58 of the spring member 56, engages a ball detent socket 60 as illustrated in FIGS. 9-10. The ball detent 59 and the ball detent socket 60 combine to releasibly retain the pivoting knife blade 14 in the fully stored position. Pressure exerted upwardly from the spring member 56 against the bottom of the pivoting knife blade 14 locates the ball detent 59 within the ball detent socket 60 while the knife blade 14 is in this fully stored position (FIG. 11).

Pivoting the knife blade 14 toward the fully deployed position (FIG. 12) disengages the ball detent 59 from the ball detent socket 60. The knife blade 14 pivots across the tip of the ball detent 59, thereby experiencing minimal resistance because of the limited surface area contact between the tip of the ball detent 59 and the surface of the knife blade 14. When the knife blade 14 reaches the fully deployed position, the front end 58 of the spring member 56 shifts downwardly to the position shown in FIG. 12. This front end 58 defines a relatively flat edge which moves behind and engages a corresponding flat edge 61 (FIGS. 6, 11-12) of the knife blade base end 40, when the knife blade 14 is in the fully deployed position. In a particularly preferred embodiment, both the front end 58 and the flat edge 61 are formed having engageable 10° angles, although any combination of engageable angles are possible. As a result, the front end 58 of the spring plate 54 effectively locks and blocks the pivoting knife blade 14 in the deployed position (as shown best in FIG. 12). A person of ordinary skill in the art will readily recognize that many different releasible locking mechanisms are available for use with the present invention in order to effectively lock the pivoting knife blade 14 in the fully deployed position. Such devices might include spring, clip, snap, or non-friction mechanisms, and may utilize notches, pins, buttons, bars, coils, nuts and/or bolts or any combination thereof.

The pivoting knife blade 14 is quickly and easily released or unlocked for return pivoting motion from the deployed position to the stored position, when and if desired. The spring plate 54 defines a laterally outboard-presented serrated edge 62 along the external portion of the spring member 56, which terminates substantially coextensive with the adjoining side edge or side margin 32 of the housing members 18, 20. This serrated edge 62 is thus exposed for easy manipulation manually to shift the flat-shaped front end 58 of the spring member 56 upwardly within the slot 48 for spring member misalignment with the plane of the knife blade 14. In this misaligned position of the spring member 56, the knife blade 14 can be pivotally displaced back to the stored position nested at least partially within the side-open slot 48 in the handle housing 12. During the pivoting motion, the knife blade 14 contacts and rotates along the tip of the ball detent 59. When the knife blade 14 is in the fully stored position, the ball detent 59 re-engages the ball detent socket 60 as previously described. Upon subsequent return movement of the knife blade 14 back to the deployed position (FIG. 2), the spring member 56 on the spring plate 54 biases the spring member front end 58 against the knife blade 14 (FIG. 12) for automatically yet releasibly re-locking the knife blade 14 in the deployed position.

The utility blade 16 as shown best in FIG. 6 comprises a conventional razor-type knife blade having a generally trapezoidal shape with an elongated side edge defining a razor-sharp cutting edge 64. A comparatively shorter and relatively blunt side edge 66, disposed opposite the cutting edge 64, has a pair of laterally open mounting recesses 68 formed therein. Leading and trailing edges 70 and 72 of the utility blade 16 respectively extend angularly forwardly and angularly rearwardly from the blunt edge 68 to the cutting edge 64.

This utility blade 16 is adapted for reversible and removable mounting onto a slide clip 74 (FIGS. 6-8) carried between the two housing members 18, 20 for fore-aft sliding displacement to shift the utility blade 16 between the stored position concealed within the handle housing 12 and the deployed position projecting forwardly from the angularly tapered face 30 at the front end 24 of the handle housing. In this regard, the utility blade 16 is seated on the slide clip 74 with a rear portion or rear half of the blade 16 supported on a platen 76 which extends between a lower rail 78 and an upper rail 80. A pair of mounting keys 82 are formed adjacent the upper rail 80 for seated reception into the mounting recesses 68 formed in the utility blade 16. In a preferred form, the slide clip 74 is constructed from a molded plastic material, spring metal, stamped, or similar material suitable for carrying the blade 16 without significant damage to the razor-sharp cutting edge 64 supported by the lower rail 78. Importantly, when the utility blade 16 is thus mounted onto the slide clip 74, a forward portion or forward half of the blade 16 protrudes forwardly from the slide clip 74.

The slide clip 74 is captured between the assembled housing members 18, 20 for fore-aft sliding displacement. In this regard, the assembled housing members 18, 20 cooperatively define a slide track for retaining and guiding the slide clip 74 with utility blade 16 supported thereon between the retracted (stored) and advanced (deployed) positions. A track extension 84 of the side clip 74 mates to a corresponding track ledge 85 (shown best in FIGS. 9-10) formed in the upper housing member 18 to facilitate movement between retracted and advanced positions. A thumb key or thumb detent 86 on a rear end of a short spring arm 87 forms an integral portion of the slide clip 74, and wherein this thumb detent 86 is externally exposed through a fore-aft elongated track port 88 (FIGS. 1-3 and 5-6) formed in the upper housing member 18. At least one and preferably a pair of laterally elongated side wings 90 formed at the base of this thumb detent 86 are sized to project at least partially into aligned detent seats 92 formed in the lower housing member 20 at an inboard surface thereof lining the track port 88 as illustrated in FIG. 6.

Accordingly, by depressing the thumb detent 86 sufficiently to disengage the side wings 90 from the associated detent seats 92, the slide clip 74 with the utility blade 16 can be shifted forwardly or rearwardly relative to the track port 88. In the rearmost slide clip position along the track port 88, the utility blade 16 is retracted to the stored and concealed position. Conversely, in the forwardmost slide clip position along the track port 88, the utility blade 16 is shifted to a fully exposed deployed position with the cutting edge 64 exposed laterally outwardly relative to the handle housing 12 in a direction opposite to the cutting edge 36 of the knife blade 14 in a deployed position. The detent seats 92 engage the side wings 90 for releasibly locking the slide clip 74 and blade 16 in the desired stored or deployed position. Multiple intermediate sets of the detent seats 92 are provided for multiple partially deployed positions of the utility blade 16.

In accordance with a further aspect of the invention, the utility blade 16 is adapted for quick and easy removal from the handle housing 12, without requiring disassembly of the housing members 18, 20. In this regard, such removal of the utility blade 16 is periodically necessary to reverse the blade 16 relative to the slide clip 74, and/or to replace a worn blade with a new one.

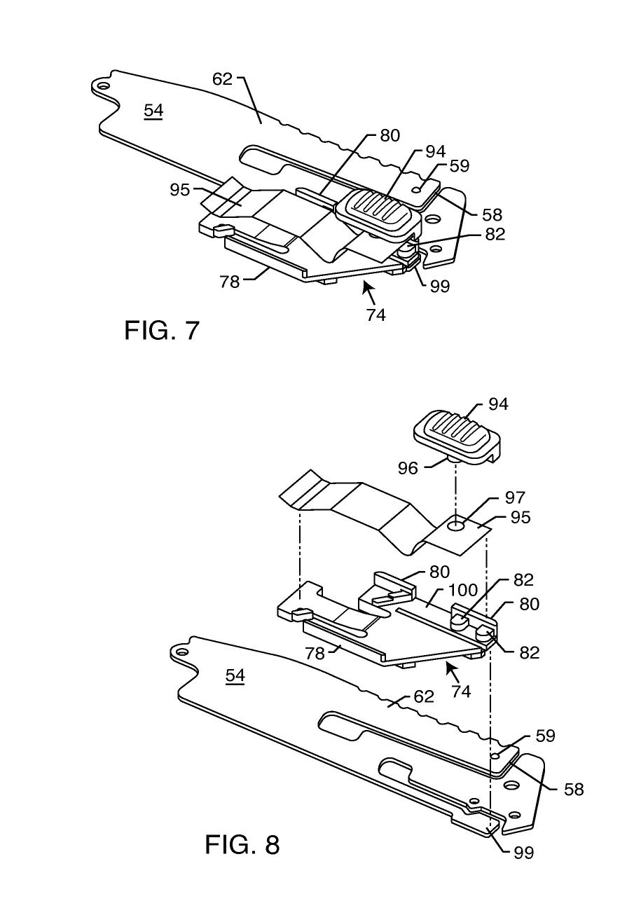

More particularly, when the slide clip 74 is in the forwardmost position for supporting the utility blade 16 in the deployed position, the slide clip 74 is oriented with its upper rail 80 in a position directly underlying a release button 94 (shown best in FIGS. 7-10) and tensioned upwardly by a release spring 95 mounted within the handle housing 12. FIG. 8 shows an exploded perspective view of the release button 94 having a connection post 96 that locates the release button 94 in an aperture 97 formed in the release spring 95. The release spring 95 is widened and lengthened to keep the utility knife blade 16 from rattling. The release spring 95 provides continual upward pressure to the release button 94, even when the slide clip 74 is in the stored position. Additionally, the release spring 95 provides continual downward pressure on the thumb detent 86 to ensure continual external exposure through the lower housing member 18 in the retracted and deployed positions. Importantly, the release button 94 is externally exposed through a matingly shaped release port 98 formed in the lower housing member 20 for convenient fingertip depression.

As previously described, and as shown best in FIGS. 9-10, the upper rail 80 on the slide clip 74 underlies the release button 94 when the slide clip 74 is in the forward most position with a portion of the utility blade 16 projecting from the front end 24 of the handle housing 12. Depression of the release button 94 in this orientation shifts the upper rail 80, associated mounting keys 82, and a spring tab 99 relative to the utility blade 16, in a direction toward the opposite housing member 18. In this regard, it is noted that the upper rail 80 and mounting keys 82 of the slide clip 74 are carried generally at a free end of yet another short spring arm 100 formed integrally with the slide clip 74, to accommodate this shifting displacement relative to the blade-supporting platen 76 of the slide clip 74. This clip spring arm 100 is supported (in the forwardmost slide position) on the spring tab 99 of the spring plate 54. By configuring the upper rail 80 so that it is taller than the mounting keys 82, depression of the release button 94 can displace the mounting keys (downwardly, as viewed in FIG. 10) sufficiently to clear the blade mounting recesses 68, thereby releasing the blade 16 for manual grasping and slide-out removal from the handle housing 12.

The utility blade 16 can be re-installed quickly and easily into the handle housing 12 in the same or a reversed orientation, or a replacement blade 16 can be installed, by sliding the blade rearwardly into the handle housing 16 while holding the release button 94 in the depressed position. When the rear margin of the re-installed blade 16 engages an upstanding backstop structure 102 on the slide clip 74, the release button 94 is released to permit spring-loaded travel of the mounting keys 82 (upwardly, as viewed in FIG. 10) into re-engagement with the blade mounting recesses 68.

Various modifications and improvements in and to the multiblade knife unit 10 of the present invention will be apparent to persons skilled in the art. As one example, the handle housing 12 may incorporate a tether port 104 (FIGS. 1-4) for receiving a tether (not shown) or the like, if desired.

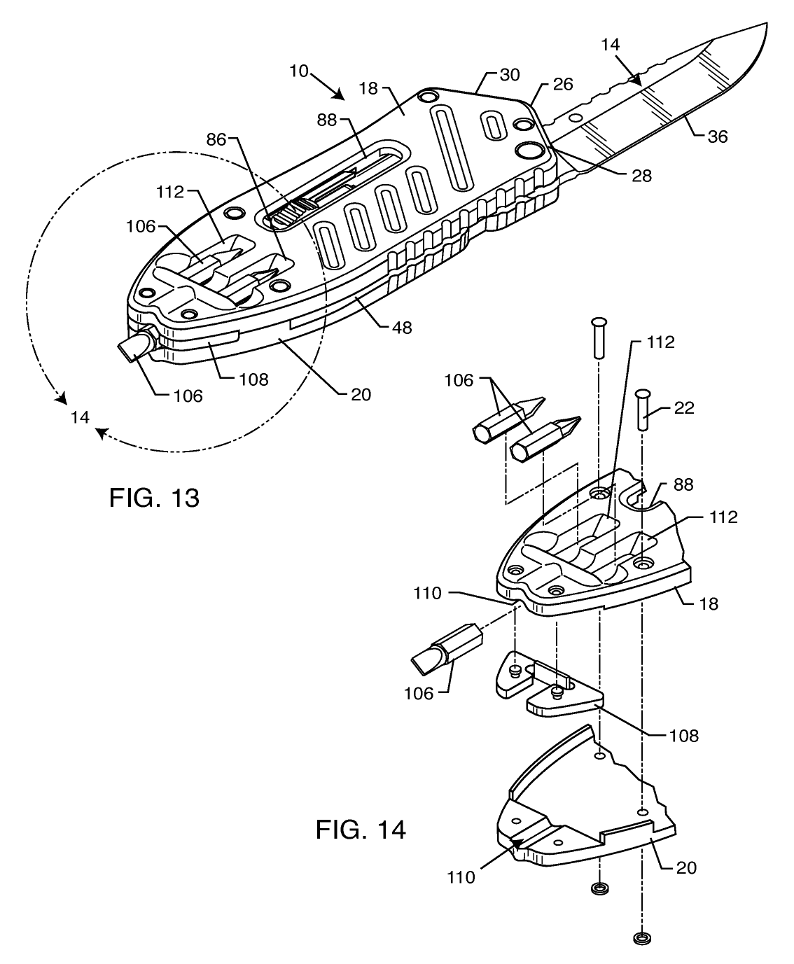

Alternately, as viewed in FIGS. 13-14, the handle housing 12 can be modified to include a plurality of driver bits such as screwdriver bits 106 for selective deployment at the end opposite the deployed knife blade or blades, such as the pivoting knife blade 14 as shown. In this alternative embodiment, the housing members 18, 20 are adapted in combination with a plate-shaped insert 108 to define a hex-shaped bit socket 110 or the like for removably receiving and supporting a selected one of the bits 106, such as flat-blade screwdriver bits or different sizes, and/or one or more Phillips-type, hex, torqux bits. A driver bit 106 supported in the hex socket 110 projects rearwardly from the handle housing 12, in a direction opposite the deployed knife blades, for appropriate use. Unused bits driver 106 may be removably stored in associated detent cavities 112 formed, e.g., on the outboard side of the upper housing member 20.

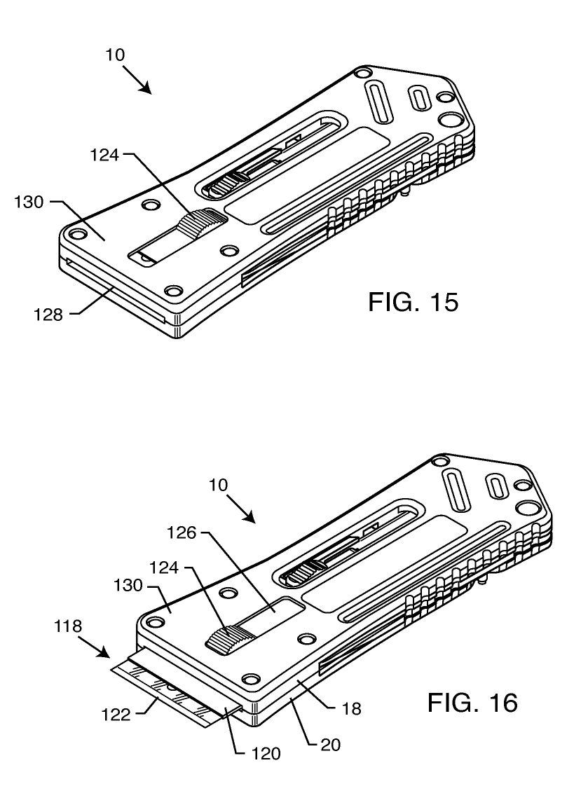

In another alternative embodiment of the present invention, the knife unit 10 further includes a paint scraper 118 as shown in FIG. 16. The paint scraper 118 comprises a blade holder 120 and a paint scraper blade 122. The blade holder 120 is accessible for fingertip access through the exterior of the upper housing member 18 by means of a thumb detent 124. The thumb detent 124 slides within a detent port 126 formed in the upper housing member 18. The blade 120 slides within a track (not shown) formed between the upper housing member 18 and the lower housing member 20. The paint scraper 118 is in the stored position within the handle housing 12 as shown in FIG. 15. Accordingly, the thumb detent 124 is positioned toward the middle of the knife unit 10. The paint scraper 118 extends through an extension slot 128 as the thumb detent 124 is pushed away from the middle of the knife unit 10 and toward a back end 130. Accordingly, the paint scraper blade 122 projects out from the back end 130 and through the extension slot 128 once the thumb detent 124 is pushed all the way toward the back end 130 within the detent port 126 of the knife unit 10. The paint scraper blade 122 may be removed and replaced when in the extended position as shown in FIG. 16.

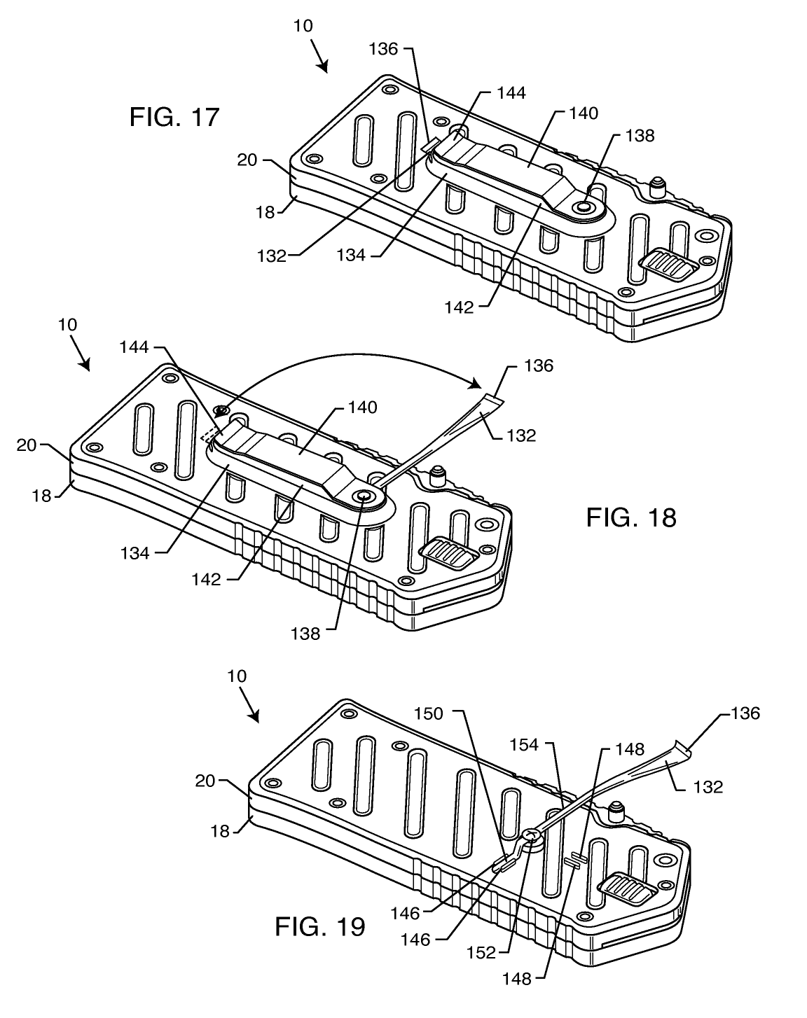

The knife unit 10 of the present invention may further include a can opener 132 as best shown in FIG. 18. Referencing FIG. 17, the can opener 132 resides within a housing 134 when in a stored position. The housing 134 substantially encompasses the length of the can opener 132 to provide protection and prevent inadvertent rotation during storage. The housing 134 also helps to prevent inadvertent engagement of the can opener 132, such as with a loose clothing article, during periods of non-use. The housing 134 may be attached to the lower housing member 20 by any method known in the art, including adhesive or mechanical engagement. In the embodiments shown in FIGS. 17 and 18, the housing 134 is mechanically attached to the lower housing member 20 via a set of rivets (not shown). As best shown in FIG. 17, a can opener tip 136 extends out from one end of the housing 134 to provide fingertip access thereto. Accordingly, the tip 136 is accessible to move the can opener 132 from the stored position (FIG. 17) to an extended position (FIG. 18). Applying pressure to the can opener tip 136 along the arced arrow in FIG. 18 rotates the can opener 132 clockwise to the extended position. The can opener 132 rotates about a rivet 138 and relative to the knife unit 10 and corresponding housing 134. The can opener 132 is sufficiently attached to the knife unit 10 via the rivet 138 such that the can opener 132 will easily withstand shear and tensile forces exerted upon the attachment mechanism when opening a can, such as a paint can. After use, the can opener 132 is simply rotated counterclockwise from the extended position as shown in FIG. 18 to the stored position as shown in FIG. 17.

Furthermore, the knife unit 10 includes a belt clip 140 attached to a top surface 142 of the housing 134. The belt clip 140 is preferably a tension spring connected to the lower housing member 20 via the housing 134 by means of the rivet 138. The belt clip 140 includes an outward extending flange 144 to better enable slide-in application to a belt or other similar item. The outward extending flange 144 provides a larger gap between the belt clip 140 and the top surface 142 of the housing 134 for insertion of the belt or other comparable item therein. The belt clip 140 may be mounted directly to the lower housing member 20, especially when the housing 134 and the corresponding can opener 132 are unneeded. Alternatively, the belt clip 140 may be excluded altogether, leaving only the housing 134 and corresponding can opener 132.

In an alternative embodiment, the can opener 132 can be mounted directly to the lower housing member 20 and be curved similar to the belt clip 140 in FIG. 18. In this embodiment, the can opener 132 replaces the belt clip 140 as a mechanism for attaching the multiblade knife unit 10 to a belt or other article suitable for transportation during non-use. In essence, the can opener 132 functions as a belt clip when in the stored position. In this embodiment, the can opener tip 136 is preferably bent away from the lower housing member 20 like the flange 144 of the belt clip 140 in FIG. 18 to facilitate insertion of a belt or other comparable item therein. Additionally, a pair of locking rails 146,148 retains a backend 150 of the belt clip 140. FIG. 19 illustrates the backend 150 retained by the locking rails 146 such that the can opener 132 is held in an extended position. Accordingly, the can opener 132 may be pivoted about a screw 152 to a stored position wherein the can opener 132 is aligned substantially along the longitudinal length of the multiblade knife unit 10 and retained by the locking rails 148. Alternatively, a neck 154 of the can opener 132 may be held by either of the locking rails 146, 148 when the can opener 132 is in the stored or extended positions. The locking rails 146, 148 merely provide a mechanism for substantially retaining the can opener 132 in either the stored or extended positions.

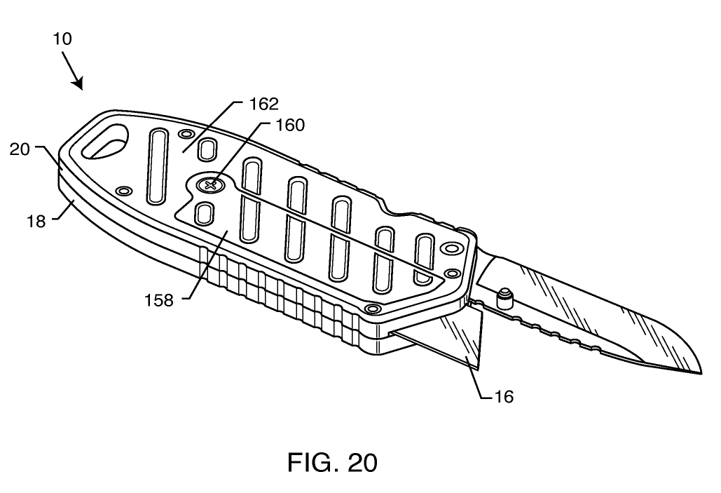

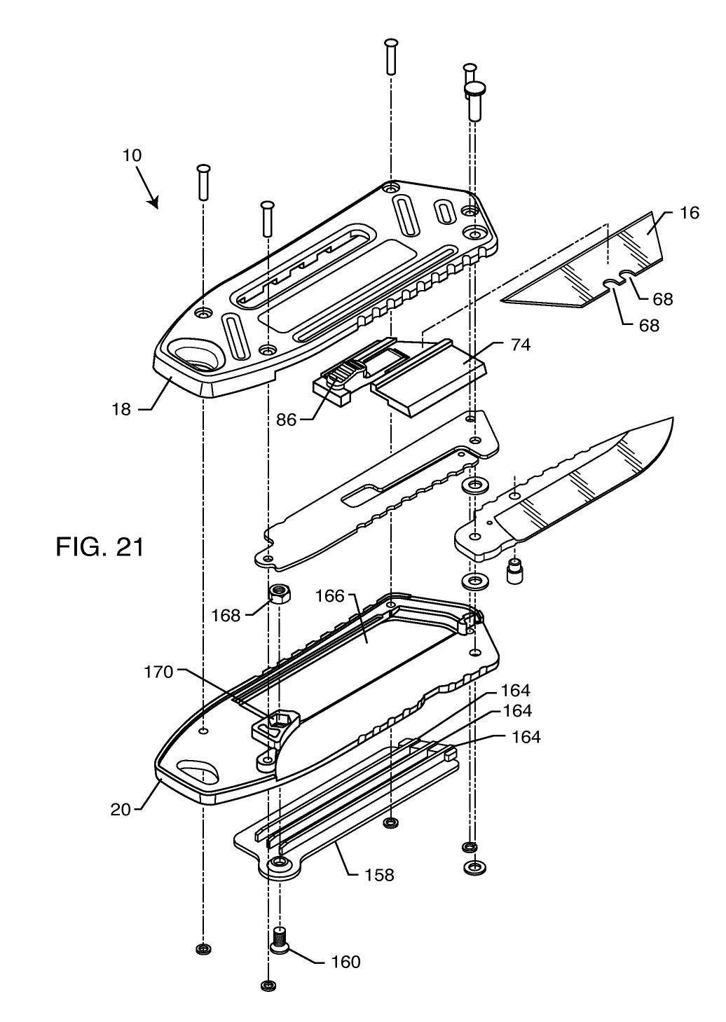

FIG. 20 illustrates an alternative embodiment of the multiblade knife unit 10 having a removable door 158 integrated into the lower housing member 20. The door 158 replaces the release button 94 as described and shown in FIGS. 4-10. The door 158 is secured to the multiblade knife unit 10 via a screw 160. As shown in FIG. 20, the door 158 is preferably flush with a top surface 162 of the lower housing member 20. FIG. 21 illustrates an exploded view of the door 158 as replacing the release button 94 and corresponding release mechanism. The door 158 has a series of extrusions 164 that the utility knife blade 16 slides against when the thumb detent 86 moves the utility knife blade 16 from the contracted position to an extended position. The extrusions 164 extend into an aperture 166 formed in the lower housing member 20. The extrusions 164 bias the utility knife blade 16 against the underside of the slide clip 74. As best shown in FIG. 23, the slide clip 74 includes the pair of mounting keys 82 that fit into the laterally open mounting recesses 68 (FIG. 21) to retain the utility knife blade 16 therein. As shown in FIG. 21, the screw 160 is secured to the lower housing member 20 by means of a nut 168 that resides in a similarly shaped housing 170. As shown, the nut 168 is a hex nut and resides in a hex nut housing 170. This enables the screw 160 to be tightened with a screw driver or other comparable tool from the outside of the multiblade knife unit 10.

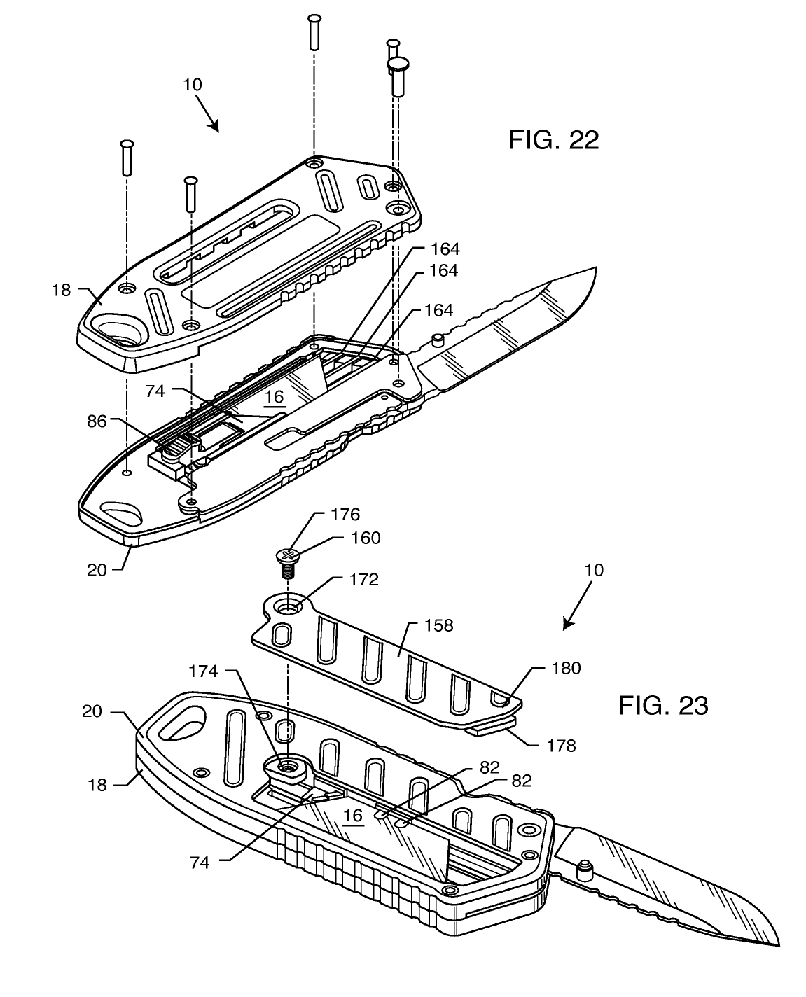

FIG. 22 illustrates the utility knife blade 16 residing within the lower housing member 20 and sandwiched between the extrusions 164 of the door 158 and the slide clip 74. The slide clip 74 and the corresponding thumb detent 86 move the utility knife blade 16 between the contracted and extended positions, as previously described. The slide clip 74 is operable only after the door 158 is secured to the lower housing member 20. After inserting the utility knife blade 16, the screw 160 is placed through an aperture 172 formed in the door 158 and screwed into a threaded housing 174. The screw 160 is preferably tapered such that a head portion 176 of the screw 160 is wider in width than the corresponding aperture 172 formed in the door 158. The door 158 is held in place by wedging an extension 178 formed at a front end 180 of the door 158 into a slot (not shown) formed on the corresponding side of the lower housing member 20. This secures the front end 180 of the door 158 to the lower housing member 20. When the utility knife blade 16 is completely encased within the multiblade knife unit 10 as shown in FIG. 20, the thumb detent 86 may move the utility knife blade 16 between the contracted and extended positions as already described herein.

Further modifications and improvements will be apparent to those persons skilled in the art. Accordingly, no limitation on the invention is intended by way of the foregoing description and accompanying drawings, except as set forth in the appended claims.

What is claimed is:

1. A multiblade knife, comprising:
a handle;
a first blade attached to the handle and pivotally moveable between a first folded position and a second extended position projecting generally out from a first end of the handle;
a second blade slidably mounted to the handle for sliding displacement between a first contracted position substantially within the handle and a second extended position projecting generally out from the first end, the first and second blades being displaceable independent of one other; and
a third blade slidably mounted to the handle for sliding displacement between a first retracted position within the handle and a second extended position projecting generally out from a second end of the handle.

2. The multiblade knife of claim 1, including a carriage slidably movable along a track within the handle for displacing the second blade between its first and second positions.

3. The multiblade knife of claim 2, wherein the carriage is accessible through the handle for manually moving the second blade between its first and second positions.

4. The multiblade knife of claim 2, including a release mechanism for releasibly mounting the second blade to the carriage when in the extended position, thereby permitting manual removal and replacement of the second blade.

5. The multiblade knife of claim 1, including a blade holder slidably mounted within the handle for selectively moving the third blade between its first and second positions.

6. The multiblade knife of claim 5, wherein the blade holder is accessible through the handle for manually moving the third blade between its first and second positions.

7. The multiblade knife of claim 5, including a release mechanism for permitting manual removal and replacement of the third blade when the blade holder is in the extended position.

8. The multiblade knife of claim 1, including a can opener pivotally attached to the handle.

9. The multiblade knife of claim 8, wherein the handle includes a housing for storing the can opener in a first stored position.

10. The multiblade knife of claim 9, wherein the can opener is accessible for pivoting from its first position to a second position extending from the handle.

11. The multiblade knife of claim 1, including a belt clip fixed to the handle.

12. The multiblade knife of claim 1, wherein the first and second blades respectively define cutting edges presented in opposite directions, when the first and second blades are in the extended positions.

13. The multiblade knife of claim 1, wherein the first blade includes a post for facilitating manual displacement of the first blade from its first folded position to its second extended position.

14. The multiblade knife of claim 1, including a locking mechanism comprising a spring plate for releasibly locking a base end of the first blade in the extended position.

15. The multiblade knife of claim 14, including a slot formed along a side edge of the handle for receiving the first blade in the folded position, the spring plate having a laterally extending spring member for moving within the slot and having a front end for engaging and locking to the matingly shaped base end of the first blade when in the extended position.

16. The multiblade knife of claim 15, wherein the spring member includes a serrated side edge exposed from the handle for fingertip access within the slot for unlocking the first blade by displacing a portion of the spring member from the base end, thereby permitting pivotal displacement of the first blade from the extended position to the folded position.

17. The multiblade knife of claim 15, including a ball detent integral to the spring member for releasably retaining the first blade within the slot when in the folded position.

18. The multiblade knife of claim 1, wherein the second blade comprises a utility knife blade.

19. The multiblade knife of claim 1, wherein the third blade comprises a paint scraper.

20. A multiblade knife, comprising:
a handle;
a first blade attached to the handle and pivotally moveable between a first folded position and a second extended position projecting generally out from a first end of the handle;
a locking mechanism comprising a spring plate for releasibly locking a base end of the first blade in the second extended position;
a utility knife slidably mounted to the handle for sliding displacement between a first contracted position substantially within the handle and a second extended position projecting generally out from the first end, the first blade and the utility knife being displaceable independent of one other and respectively define cutting edges presented in opposite directions when the first blade and the utility knife are in the extended positions;
a paint scraper slidably mounted to the handle for sliding displacement between a first retracted position within the handle and a second extended position projecting generally out from a second end of the handle;
a can opener pivotally attached to the handle; and
a belt clip fixed to the handle.

21. The multiblade knife of claim 20, including a carriage slidably movable along a track within and accessible through the handle for manually displacing the utility knife between its first and second positions, the handle including a release mechanism for releasibly mounting the utility knife to the carriage when in the extended position, thereby permitting manual removal and replacement of the utility knife.

22. The multiblade knife of claim 20, including a blade holder slidably mounted within and accessible through the handle for selectively moving the paint scraper between its first and second positions, the blade holder including a release mechanism for permitting manual removal and replacement of the paint scraper when the blade holder is in the extended position.

23. The multiblade knife of claim 20, wherein the handle includes a housing for storing the can opener in a first stored position, the can opener being accessible for pivoting from its first stored position to a second position extending from the handle.

24. The multiblade knife of claim 20, wherein the first blade includes a post for facilitating manual displacement of the first blade from its first folded position to its second extended position.

25. The multiblade knife of claim 20, including a slot formed along a side edge of the handle for receiving the first blade in the folded position, the spring plate having a laterally extending spring member for moving within the slot and having a front end for engaging and locking to the matingly shaped base end of the first blade when in the extended position, wherein the spring member includes a serrated side edge exposed from the handle for fingertip access within the slot for unlocking the first blade by displacing a portion of the spring member from the base end, thereby permitting pivotal displacement of the first blade from the extended position to the folded position where a ball detent integral to the spring member releasably retains the first blade within the slot.
